(19) United States
(12) Patent Application Publication
(10) Pub. No.: US 2008/0209425 A1
(43) Pub. Date: Aug. 28, 2008

(54) Device Comprising a Communications Stick With A Scheduler

(75) Inventor: Gavin Robert Ferris, County Down (IE)

Correspondence Address: SYNNESTVEDT LECHNER & WOODBRIDGE LLP, P O BOX 592, 112 NASSAU STREET, PRINCETON, NJ, 08542-0592, US

(73) Assignee: Radioscape Limited, London (GB)

(21) Appl. No.: 12/113,433

(22) Filed: May 1, 2008

Related U.S. Application Data
(63) Continuation of application No. 10/515,657, filed on May 9, 2005.

(30) Foreign Application Priority Data
May 27, 2002 (GB) 0212176.2

(51) Int. Cl. G06F 9/46

(52) U.S. Cl. 718/102

(57) ABSTRACT

A scheduler is used to schedule execution of tasks by ‘engines’ that perform high resource functions as requested by ‘executive’ control code, the scheduler using its knowledge of the likelihood of engine request state transitions. The likelihood of engine request state transitions describes the likely sequence of engines which executives will impose: the scheduler can at run-time in effect, as the start of a time slice, look-forward in time to discern a number of possible schedules (i.e. sequence of future engines), assess the merits of each possible schedule using pre-defined parameters (e.g. memory and power utilisation), then apply the schedule which is most appropriate given those parameters. The process repeats at the start of the next time slice. The scheduler therefore operates as a predictive scheduler. The present invention is particularly effective in addressing the ‘multi-mode problem”: dynamically balancing the requirements of multiple communications stacks operating concurrently.

### BACKGROUND OF THE INVENTION

1. Field of the Invention

This invention relates to a device comprising a communications stack, the stack including a scheduler. The device performs real-time DSP or communications activities.

2. Description of the Prior Art

Modern communications systems are increasingly complex, and this fact is threatening the ability of companies to bring such products to market at all. The pressure has been felt particularly by the manufacturers of user equipment terminals (colloquially, ‘UEs’) in the wireless telecommunications space. These OEMs now find that they must integrate multiple, packet-based standards (coming, in all likelihood, from a number of independent development houses) together on an underlying hardware platform, within an ever-shortening time-to-market window, without violating a relatively constrained resource profile (memory, cycles, power etc.). We refer to this unenviable predicament as the ‘multimode problem’.

The traditional stack development approach has sometimes been referred to a ‘silo based’, because of its extreme vertical integration between software and hardware, and the general lack of any ‘horizontal’ integration with other stacks.

This silo approach breaks down dramatically when confronted with the multimode problem, for a number of reasons, amongst which:
It assumes that the stack developer ‘owns’ the underlying hardware resource and can therefore make assumptions about e.g. scratch and persistent memory buffer memory allocation. However, such assumptions are meaningless in a multi-stack environment where resources such as memory are being competitively acquired by stacks which may ‘beat’ against one another in their underlying timing.
It assumes (commonly) that the ‘worst case’ system loading can be configured at design-time, allowing resources to be assigned during the system design phase, rather than at runtime. However, this approach is essentially unworkable for multi-channel, packet based systems with a high peak-to-mean resource loading profile.
It assumes that a single design group will code the system and that the standard will not change significantly during development. Both assumptions are likely to be violated with modern communications systems. The complexity of a standard such as 3 G is so great that sensible methodologies will require outsourcing of at least certain components. And hardware platforms change rapidly (with new processors rapidly being developed that have e.g. increased hardware parallelism), not to mention that often, with complex hardware, designs must be redeployed at the last minute due to buggy substrates.

The present invention is an element in a larger solution to the above problems, called the Communications Virtual Machine (“CVM™”) from Radioscape Limited of London, United Kingdom. Reference may be made to PCT/GB01/00273 and to PCT/GB01/00278.

### SUMMARY OF THE INVENTION

The present invention, in a first aspect, is a device comprising a communications stack split into:
(i) engines designed to perform real time DSP or communications high resource functions;
(ii) executives designed to perform low resource functions, including issuing requests for engine execution tasks; and
(iii) a scheduler that receives the requests and schedules execution of those tasks by an underlying RTOS, the scheduler using its knowledge of the likelihood of engine request state transitions, obtained during simulation, to make, at runtime, scheduling decisions based on evaluating several possible future scenarios.

The likelihood of engine request state transitions describes the likely sequence of engines which the executives will impose and may be represented as a table or matrix generated during simulation) for each of several different executives: the scheduler can at run-time in effect, as the start of a time slice, look-forward in time to discern a number of possible schedules (i.e. sequence of future engines), assess the merits of each possible schedule using pre-defined parameters and weightings (e.g. memory and power utilisation), then apply the schedule which is most appropriate given those parameters. The process repeats at the start of the next time slice. The scheduler therefore operates as a predictive scheduler.

The present invention is particularly effective in addressing the ‘multi-mode problem”: dynamically balancing the requirements of multiple communications stacks operating concurrently.

The scheduler may be a service of a virtual machine layer separating the engines from the executives: in an implementation, this is the CVM, which will described later. A key feature of the CVM is that executives cannot invoke engines directly but only through the scheduler.

The scheduler may use engine resource utilisation profiles; these may cover both cycles and memory. The scheduler may decide which engine execution tasks are to be submitted to the underlying RTOS for execution, how many RTOS threads to use, at what priority and at each logical timestep.

In an implementation, the scheduler operates a runtime scheduling policy comprising a heuristic forward scenario generator that takes a set of submitted immediate engine requests and generates an incomplete set of possible future scenarios, based upon the state transition information. The scheduler may operate a runtime scheduling policy comprising a set of planning metrics that can be used to evaluate each of the possible future scenarios, weighing up the relative importance of one or more of the following factors: (a) memory utilisation, (b) timeslice utilisation, (c) proximity to deadline, (d) power utilisation, and generating a single scalar score.

The planning metrics may reflect choices made at design time to weight the factors differently, for example, whether the device responds early or late to resource shortages.

The scheduler may operate a dispatcher that takes the highest scoring such scenario and schedules all forward non-contingent threads onto the underlying RTOS.

The scheduler may also be able to degrade system performance gracefully, rather than invoking a catastrophic failure, by failing some requests in a systematic manner.

### BRIEF DESCRIPTION OF THE DRAWINGS

The present invention will be described with reference to the accompanying Figures, in which:

FIG. 1—illustrates the point that without CVM, high resource functions (“HRFs”) have unknown resource requirements, fuzzy behaviour, and non-standard inbound and outbound interfaces;

FIG. 2—illustrates the point that CVM engines have known resource requirements, conformed behaviour, standardised interfaces, making them genuinely commoditized components;

FIG. 3—shows that the CVM runtime provides resource management and scheduling, decoupling executives from engines;

FIG. 4—is a CVM design flow summary;

FIG. 5 is a workflow diagram for developing a CVM engine;

FIG. 6 is a screen shot from RadioScape's System Designer IDE (Integrated Development Environment).

FIG. 7 depicts a conceptual model of an engine state transition probability matrix derivation

FIG. 8 depicts how the system designer can set varying parameters and weightings

FIG. 9—depicts a sample analysis metric surface, indicating that deployments 5 through 15 are unstable

### DETAILED DESCRIPTION

The present invention will be described with reference to an implementation from Radioscape Ltd of London, United Kingdom: the CVM (communication virtual machine).

1. Overview of Predictive Scheduling

We believe that the use of predictive scheduling policies, coupled to the CVM runtime and design and simulation tools, provides a valid solution to the multimode problem (i.e. where we have a number of independent executives, which must be scheduled over a single physical thread), while not sacrificing overall system efficiency.

Under the CVM, a communications stack is split up into engines (high resource transforms, which are either implemented in custom hardware or in DSP assembly code), and executives (the rest of the software, written in a hardware-neutral language such as C). Engines must utilise a standard argument-passing format, conform in behaviour to a published model, and provide a resource utilisation profile of themselves (for memory, cycles etc.). All executives, at runtime, must request engine execution exclusivel through a shared CVM service, the scheduler; they may not invoke engines directly. Only the CVM scheduler may decide which of the requested tasks to forward to the underlying RTOS for execution, on how many RTOS threads, with what relative priority. Engines have run-to-completion semantics.

An approach that we believe provides a solution to the multimode problem, and which addresses the shortcomings just discussed, is termed predictive scheduling. Under this paradigm, engine request transition likelihood tables, constructed during simulation runs, are used, together with the called engines' resource utilisation profiles, to allow the scheduling policy at runtime to ‘look forward’ in time and dynamically balance the requirements of multiple concurrent stacks.

The technique may also be referred to as ‘stochastic’ because some of the engine request state transitions are probabilistic and may therefore be written as expressions of a random variable. Additionally, the engine resource profiles themselves may be expressed stochastically, where for example the number of cycles required by a task is not simply a deterministic function of the dimensions of its inputs (consider e.g., a turbo coder that will take more cycles to process a more corrupted input vector).

1.1 Claimed Benefits of Predictive Scheduling and CVM

Our contention is: “that predictive scheduling under CVM should successfully generate valid serialised schedules for a significant class of ‘multimode problem’ scenarios where silo based approaches fail, and furthermore, that it should beat ‘simple RTOS’ scheduling approaches for such problems too.”

We additionally assert:
That the use of predictive scheduling will provide significant benefits, through its use of additional information, not available to conventional approaches, to balance inherently bursty requirements at run time between multiple competing stacks.
That the CVM paradigm of resource-profiled engines (high-resource basic transforms) is central to this endeavour, because it provides additional information to the scheduler about the most significant resource consumers a priori, and because such an approach is necessary if large-scale Monte Carlo traffic simulation of multi-mode systems is to be performed efficiently.
That the CVM simulation tools are necessary because they provide the engine request transition probability matrix for each executive.
That a static schedule is inappropriate for bursty and/or multi-mode systems, because such systems will tend to have high peak-to-mean resource utilisation profiles, and static schedules done at design time will tend to focus on ‘worst case’ analysis, leading to inefficient or unimplementable designs.
That the CVM runtime scheduler, by separating executives from the engines that they wish to invoke, is a necessary step that prevents developers falling into the ‘silo mode’ trap and enables resources to be shared.
That all significant resources, not simply cycles, require scheduling; therefore, memory must also be scheduled. The use of a memory scheduler allows the end system to approach the efficiency ‘silo mode’ approaches that fix all or most buffers at design time, while still allowing for burstiness and ‘beating’ multi-stack, multi-vendor implementations.

2. Overview of the Communication Virtual Machine (CVM)

The CVM is a combination of run-time middleware and design-time tools that together help users implement a development paradigm for complex communication stacks.

The underlying conceptual model for CVM is as follows. We assume that a communication stack (particularly at layer 1) may be decomposed into:
High-resource, largely-application-neutral components, which will probably be implemented either in dedicated hardware or in highly platform-optimised software. These we call engines, and examples would be: FFT, FIR filter, vector multiply, etc. In the general case (where the particular CVM engine constraints are not met), we refer to such blocks as high-resource functions, or HRFs.
Low-resource, largely application-specific components, which will probably contain nothing that inherently binds them to a particular underlying hardware substrate. These we call executives, and examples would be the overall dataflow expression of a data plane, the acquisition and tracking logic in a supervisory plane, and the channel construction and deletion logic in a control plane. In the general case (where the particular CVM executive constraints are not met), we refer to such software as low-resource control code, or LRCC.
The real time operating system RTOS), which partially shields the software from the underlying hardware platform.

Unfortunately, most system designs have tended to centre around a ‘silo’ paradigm, according to which assumptions about HRF implementation, resource usage, call format and behaviour have been allowed to ‘leak out’ into the rest of the design. This has led to a number of quite unpleasant design practices taking root, all under the banner of efficiency. For example, knowing how long various HR-Fs will take to execute (in terms of cycles), and how much scratch memory each will require, it often becomes possible for the system designer to write a static schedule for scratch, allowing a common buffer e.g. to be used by multiple routines that do not overlap in time, thereby avoiding potentially expensive and non-deterministic calls to malloc( ) and free( ). However, such a design also tends to be highly fragile; should any of the HRIs be re-implemented (causing a modification in their resource profiles and/or timings), or if the underlying hardware should change, or (worst of all!) if the stack should be compelled to share those underlying resources (including memory), with another stack altogether (the multimode problem), then it is a virtual certainty that a ground-up redesign will be called for. Silo development is the embedded systems equivalent of spaghetti programming (where the hardwiring is across the dimension of resource allocation, rather than specifically program flow), and with the advent of complex, packet based multimode problems, it has reached the end of its useful life.

2.1 CVM Makes HRFs Into Engines

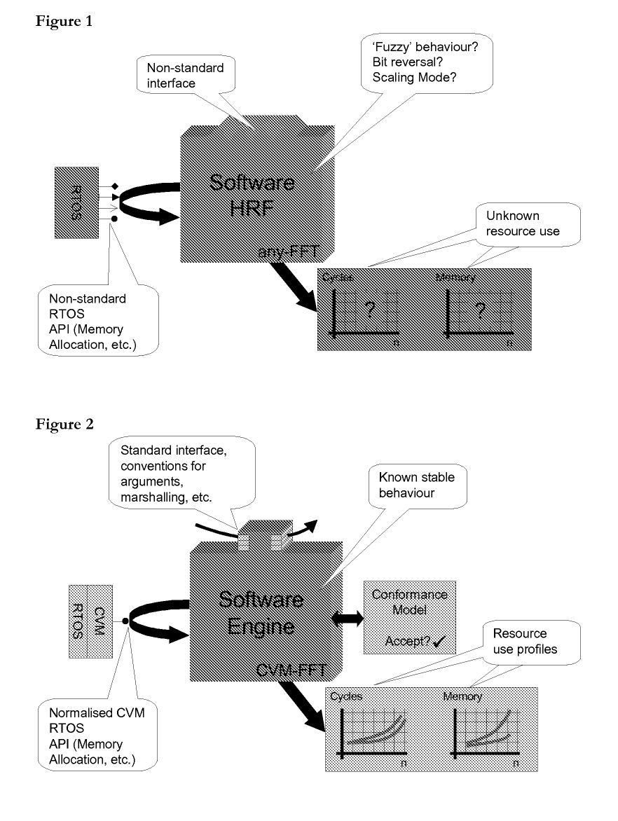

The first step away from silo development that CVM takes is in the area of HR-Fs (high-resource functions). In a typical wireless communications stack, nearly 90% of the overall system resources are consumed in such functions. However, in systems developed without CVM, HRIs (such as an FFT, for example), tend to be quite variable across different implementations. This is illustrated in FIG. 1.

The drawbacks here are:
Non-standard inbound API—calls to different vendors' FFT libraries are likely to utilise different argument lists, potentially even with different marshalling. This does not tend to promote interoperability.
Non-standard outbound API—different vendors' FFTs will probably require different services from the underlying RTOS, including memory allocation etc. Again, this tends to lower the extent to which they can be treated as commodities.
‘Fuzzy’ behaviour—everyone is pretty clear what a 16-bit IQ FFT should do, but there is still scope for considerable differences between implementation. For example, is bit reversal implemented? What about scaleback? Etc. Such differences in behaviour pose real problems for system designers.
Finally (and this is the most important for the present invention), unknown resource requirements. What will be the implications of calling this vendor's FFT in terms of memory (scratch and persistent), cycles, power, etc.? How will these requirements change as the size of the input vector changes? Without such data, published in a standard manner, intelligent scheduling becomes next to impossible.

CVM engines are HRFs with certain aspects standardized. This is illustrated in FIG. 2, above.

In comparison with the HRF case just considered, the CVM engine has the following attributes:
A standardised inbound API—meaning that all implementations of the FFT (for a given arithmetic model polymorph) will be called in precisely the same manner, regardless of underlying implementation.
Standard outbound API. In fact, engines are stipulated to have run-to-completion semantics within their thread domain (meaning that they never have to lock memory explicitly), and the only RTOS calls they may make are for dynamic memory allocation. Even then, it is strongly preferred that all of an engine's memory requirements be published up-front in its resource profile (see below), in which case no outbound interfaces at all are required for the engine implementer, who merely has to extract the necessary vector pointers to the arguments (and to any allocated scratch and persistent buffers), before (typically) dropping straight into assembler.
Known behaviour—all CVM engine implementations must be conformance tested against a ‘gold standard’ behavioural model—a reference engine—under an appropriate specification of equivalence. RadioScape publishes a number of standard models (i.e reference engines) (including, as it happens, a polymorphic FFT); developers may publish their own if required.
Finally, known resource requirements. All engines must have their resource usage profiled against at least cycles and memory for a range of vector dimensions and this information published as part of the component metadata. The resource requirements for memory should cover (explicitly) any required scratch and persistent memory, together with their formal parameter argument lists. Having this information available makes possible relatively accurate traffic-level simulation, as well as more intelligent run-time scheduling policies.

2.2 CVM Executives May Not Directly Call Engines

Of course, having these nicely standardised HRFs in the form of engines is only part of the solution. We have now isolated most of our system's expensive processing inside commoditized components (engines) with known behaviour, standard APIs and profiled resource usage.

Yet all this would be for naught, from a resource scheduling point of view, if we allowed engines to be called directly by the high level code. This is because direct calls would, more or less, determine the underlying execution sequence and also the threading model. The latter point is critical for an efficient implementation. Even worse, on our CVM model of an engine, the caller would be responsible for setting up the appropriate memory (of both the scratch and persistent varieties) for the underlying engine, thereby quickly landing us back with explicit resource scheduling.

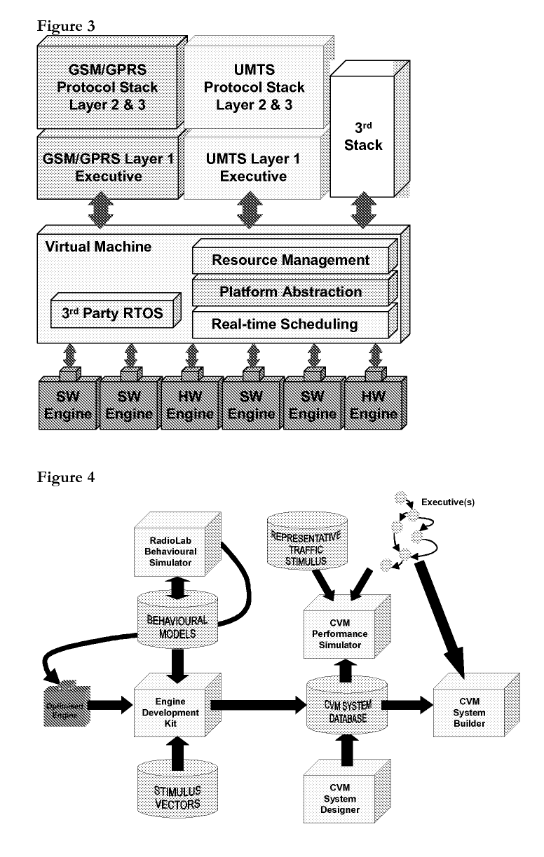

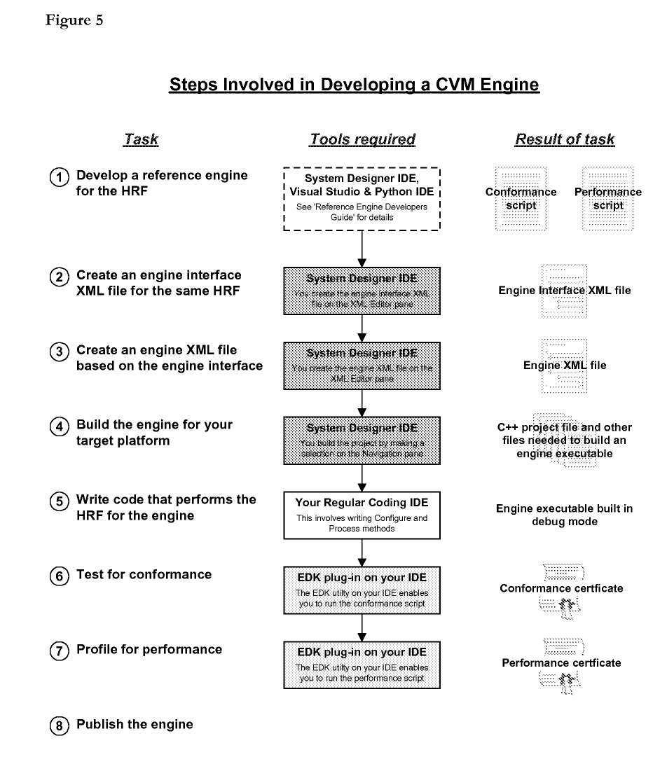

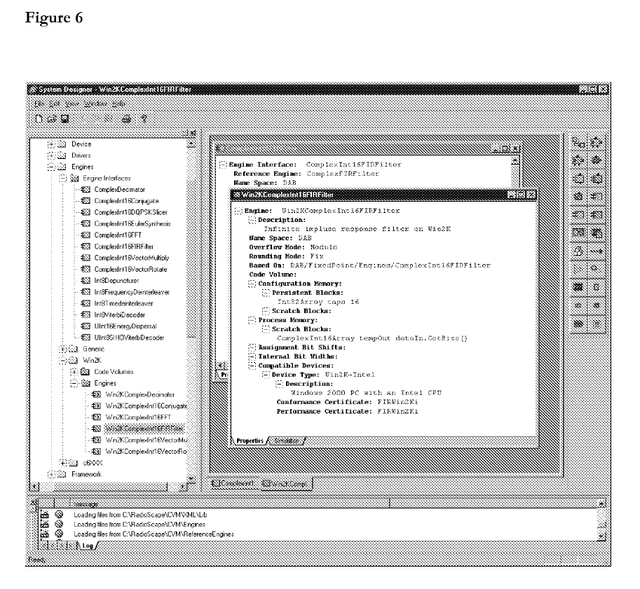

The CVM therefore takes the approach that engines must be called only via a middleware service—the scheduler. The scheduler effectively exists as a single instance across all executive process and logical threads, and decides, utilising a plug-in scheduling policy, which of these are to be submitted for execution to the underlying RTOS, using how many RTOS threads, at what priority, at each logical timestep. This is shown conceptually in FIG. 3.

2.3 CVM Tools and Design Flow

The overall design flow for the CVM is shown in FIG. 4. The RadioLab tool, using the polymorphic ‘gold standard’ reference versions of the various engines, is utilised to determine questions like the optimal bit widths for filters, likely performance of equalisers, etc. Then, a basic, high-level executive, not correct in all the details but with the vast majority of the necessary (and dimensioned, using the previous step) engine calls in place will be constructed, together with some representative traffic stimuli, and a candidate hardware platform will be selected.

In an extreme bottom-up flow, DSP engineers would then use the engine development kit (EDK), integrated with the appropriate DSP development tool (e.g., Visual DSP++) to construct optimised engines for all of the required HRFs in the system. These would be conformance tested against the gold standards and then performance profiled using the EDK.

For an extreme top-down flow, the same DSP engineers would simply publish their expected ‘forward declared’ performance profiles for the necessary engines, but would not actually write them. Reality is likely to lie somewhere between these two extremes, with the majority of needed engines either existing in engine form or requiring simply to be ‘wrapped’ and profiled, and with a few engines that do not yet exist (or have not yet been optimised) being forward declared.

Next, the designer would use the system designer to choose and deploy the appropriate number of instances of engine implementations against each required HRF from the executive. Then, a scheduling policy would be chosen using the system designer, and a traffic simulation executed. The results of this simulation would be checked against design constraints—and any mismatches would require either recoding of the ‘bottleneck’ engines, redesign with lowered functionality, or a shift in hardware platform or scheduler (and possibly a number of these).

Once a satisfactory result has been obtained (and multiple concurrent executives may be simulated in this manner), the executive developers can start to flesh out in more detail all of the necessary code inside the stack. As the executive is refined, traffic simulations should be continued to ensure that no surprising behaviour has been introduced (particularly where ‘forward declared’ engines have been used).

Finally, once all necessary engine implementations have been provided and the executive fully elaborated, an end deployment may be generated through the CVM system builder, which generates the appropriate runtime and also generates the makefiles to build the final system images.

3. The Multimode Problem

In the multimode problem case, we have a number of independent executives, which must be scheduled over a single physical thread. We have to assume that while engine resource profiles and engine call sequence transition probability maps may be available or in any case may be derived for these executives, no explicit deadline information is available (since we will probably be working from executives ‘imported’ into the CVM system initially, rather than code written explicitly for it; furthermore, the ‘event driven’ nature of processing means that it is very difficult in principle for executives to know how much absolute time remains to perform a process at any given point).

We assume that each executive is provided with a set of stimulus information for traffic-level simulation. Then the problem becomes deriving a valid serialised schedule for such a system at a specified loading, expressed in terms of a set of system parameters, such as the number of active channels, maximum throughput bitrate, etc. The ‘optimality’ of any such schedule will be constrained on the upper boundary by 100% limits on each of the resources (e.g., any schedule that uses 120% of the available memory at some point is invalid, or at least, requires further work to clarify its starvation behaviour), but below this point some weighting will determine the ‘goodness of fit’. For example, we may regard a serialised schedule that keeps memory allocation below 50% at all times desirable, and so weight our overall metric appropriately (we shall have more to say about metrics shortly, and in particular, the difference between planning metrics and analysis metrics).

3.1 Key Assumptions of the Multimode Problem

We make a number of assumptions for the stipulation of the design problem, as follows:
The major dimensions of the analysis, in terms of resource, are cycles and memory. Power (while important) is treated here as a derivative of total cycle usage.
Memory, both scratch and persistent, may be utilised by engines, components and planes.
The model may specify multiple thread domains.
The model may allow for multiple RTOS threads, but will be limited (initially) to only a single physical thread (this ignores sources and sinks to external DMA, which are run from the interrupt thread domain.)
Although it is unrealistic to require executive writers to specify per-engine deadlines, it is reasonable to express overall deadlines for a plane (or even a component), and ‘proximity to deadline’ may be then be treated as a virtual resource dimension by the scheduling policy.
The underlying RTOS is stipulated to have only two levels of priority. All tasks of an equal priority are timesliced on a round-robin basis, and are run to completion before any timeslices of a lower-priority task runs. In the case that the RTOS is part-way through running a lower priority task when a higher priority task is scheduled, that higher priority task will take preference, but scheduling only happens at the timeslice boundary.
To keep the problem simple, all RTOS timeslices are assumed to consume the same number of cycles, and all engines are assumed to consume an integral number of timeslices.
Similarly, to keep the problem simple, there is initially assumed to be only one class of memory, which is split up into a number of simple blocks of equal size (for example, 100). Each engine implementation, component and plane, it is possible to stipulate per-message persistent and scratch memory, and per-entity persistent memory. Each of these allocations is assumed to require an integral number of blocks.
Planes may create other planes—this would typically happen when a control plane activates a new channel. The creating plane then has ownership of the created plane and it alone may delete it.
Planes will have run-to-completion semantics for messages once they are dequeued. (This requirement may easily be relaxed to a per-engine schedule, but the planar map makes for a design framework that is more easily integrated with existing imperative code.)

3.2 Building a Predictive Scheduling Policy

We now consider the various steps that will be followed in the production of a predictive scheduling policy. In overview, these are as follows (more detail is provided in the following text):
1. Generate at least two high-level executives (E1 and E2) together with stimulus models and system constraints, which together cover the significant majority of the engine types called (the bit widths etc. are assumed to have been validated using a prior RadioLab analysis by this point). (N.B., the executive should have appropriate code to deal with any data dependent branches during simulation.)
2. Using a trivial scheduling policy, and without requiring actual engine implementation resource profiles, run a set of simulations of both E1 and E2, to determine an engine state transition probability matrix. This matrix, for the simple case, contains a relative-frequency-based probability estimate of the likelihood of a given engine being called, given that a known prior engine was called. All probability traces commence with a source and end (ultimately) in a sink. The matrix thus generated will be highly sparse—most transitions will be probability ‘0’, and there will be many probability ‘1’ transitions. States are tracked within a citation context (namely, plane and component hierarchy).
3. Derive or declare a set of candidate implementation engines that provide coverage of the required engine types from step 1. This will provide a set of resource profiles for each engine.
4. Provide the core components of the runtime scheduling policy. The core policy elements will contain:
   A heuristic forward scenario generator. This will take the set of submitted immediate engine requests and generate an incomplete set of possible future scenarios, based upon the state transition information.
   A set of planning metrics that can be used to evaluate each of the candidate scenarios, weighing up the relative importance of memory used, cycles consumed etc., and combining this into a single scalar ‘measure of goodness’. The initial weights for these metrics may be unknown.
   A dispatcher that will take the highest scoring such candidate scenario and schedules all forward non-contingent threads onto the underlying RTOS. The scheduler will then wait for the next request that allows it to generate a forward model containing significant new information.
5. Provide a script that allows the E1 and E2 simulations to ‘beat’ against one another, with an overall analysis metric that, after a certain time, derives an actual metric of merit from the serialised schedules.
6. Provide a mechanism to detect potential ‘resource conflicts’ within the schedules due to overlapping timings, and to ‘zoom in’ on these to resolve them and comprehend their extent.
7. Provide a mechanism to allow the weights and transfer functions associated with the various planning metrics to be systematically varied, in order to optimise the output of the analysis metric. This is the manner in which (at design time) the system is able to ‘trained towards’ a relatively optimal behaviour.
8. Finally, as a sanity check, provide a harness within which the performance of the system may be compared with that achieved by a more straightforward scheduler (such as earliest deadline first, EDF), which has neither the advantage of knowing about the likely resource loading imposed by engines nor about the likely sequence of engines which the executives impose. The predictive scheduler must be able to demonstrate a clear superiority when compared with the simpler scheduler, according to the chosen overall analysis metric. This metric must take into account the length of time required to run the scheduling policy itself.

We shall now consider each of the above steps in a little more detail.

3.3 Generation of Initial ‘Framework’ Executives

We can begin thinking about the derivation of a successful predictive scheduling policy, once we have an understanding of the core algorithmic datapaths in our multimode system. This will have been derived from a prior analysis using a bit-true numerical simulator (such as RadioLab or SPW). It is assumed, in other words, that at the beginning of the analysis the system designer understands the primary HRFs that have to be ‘strung together’ in order to fulfil the requirements of the stack, and furthermore knows the bit widths at which each HRF must operate in order to satisfy the core engineering quality targets of the multimode system.

With this knowledge, it is assumed that the system engineer can put together a basic ‘framework’ executive, which will represent calls to all the major engine types required in an appropriate order, within the data, control and tracking planes of the modem.

These ‘proto-executives’ will probably not contain much in the way of detailed processing or inter-plane messaging at this stage, but are simply intended to represent the majority of the engine calls (and hence, by extension, resource loading) that will be imposed by the running system. It is assumed that the executives are written in a manner that yields them suitable for traffic simulation (in which engines called are not actually executed, in order to save time). Therefore, any data-dependent branches in the executive code will have to be written with polymorphs to be invoked during simulation runs. With this, and assuming that the system engineer is able to construct (or capture from a live system) a realistic stimulus set for each of the executives (for example, E1 and E2), the first phase of simulation proper may begin.

3.4 Derive State Transition Probability Matrix

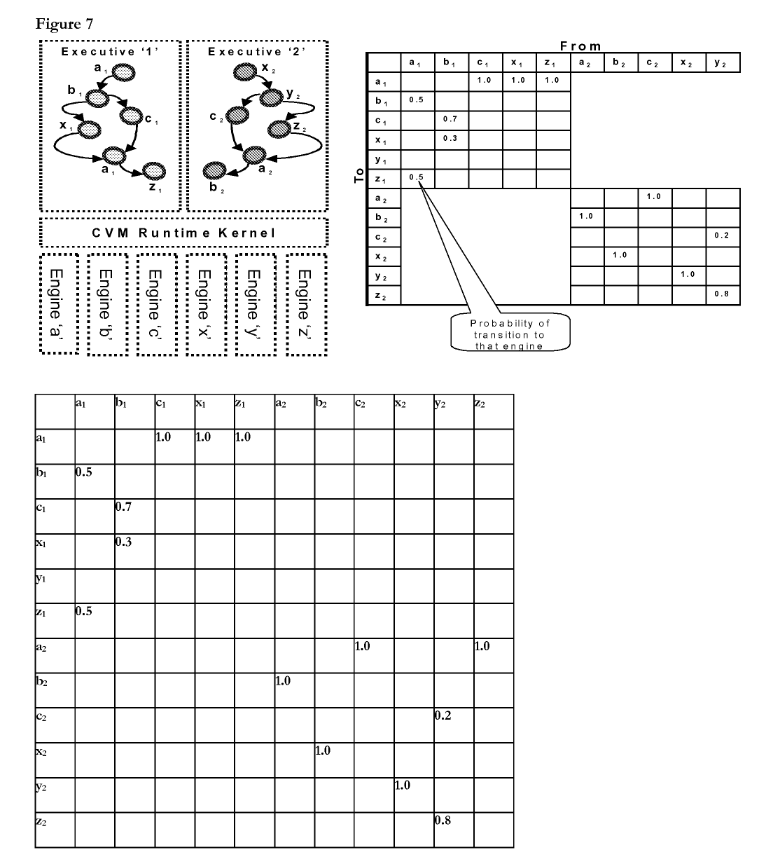

At this point, we are not interested in (and nor do we necessarily have access to) the engine profiles for the underlying implementations. None of this really matters here—what we are after is an analysis of the algorithmic flow. Our goal is to build up an engine request probability matrix based upon the calls that are made, as is illustrated conceptually in FIG. 7.

As may be appreciated, the derived matrix is sparse, with many ‘0’ transitions, and a number of ‘1’ transitions. However, in a typical stack with branching there will be some probabilities between 0 and 1, which is the first introduction of stochastic behaviour into the system.

Note that we must be careful in the way that we specify engine transitions, to determine their context: e.g. a complex 32-bit vector multiplier might be used in two quite different locations within a stack. Furthermore, with the assumptions of run-to-completion semantics that are now possible for imperative code in CVM at the plane level, state transitions (which are flattened) are not always the most informative mode: we may prefer to work with a hierarchical transition system with planar transitions at the highest level, component transitions below this and finally looking at engine transitions only within a fully resolved (and leaf level) plane/component ‘address’.

One subtle point: the modelling of the state transitions should include modelling of stimuli that are periodically emitted by sources, otherwise we will be missing a significant amount of detail from our forward world view as incoming events (and their consequences) would otherwise take the scheduler ‘by surprise’ every time.

3.5 Generate Required Engine Resource Profiles

With the state transition probability matrices derived, the design may proceed to the next phase. For this, we will need to have real engine resource profiles for each of the types cited by the executives derived above (which in turn, will require a view about the target hardware substrate for the engines; for simplicity, we'll assume that there is only a single processor of known type at the beginning of the project, since otherwise, this would represent a significant dimension of the analysis).

There are, in effect, two ways to derive the resource profiles, and it is likely in any real project that some combination of the both will be employed. The first method involves actually having DSP engineers develop the optimised runtime code using the system development environment in conjunction with the CVM EDK (engine development kit), proving that this conforms to the required behaviour by comparing it with the same behavioural models used during the numerical simulations, and then profiling the performance of the engines (at least in terms of memory and cycles) against varying dimensions of input vector.

The second method involves DSP engineering staff (or the system engineer) making an ‘educated guess’ about the likely resource profile, and then simply forward declaring it; the idea being to determine (at an approximate level) whether the overall system makes sense, before committing to any significant engine development workload proper.

In either the ‘top down’ or ‘bottom up’ case, the resources required by an engine may be deterministic or stochastic (thereby representing a second level of randomness into the overall scheduling mix). A turbo decoder is an example of a stochastic resource engine, whose cycle-loading is not expressible as a deterministic function of its input vector dimensions only (since the number of times it loops will depend upon the corruption of the data contents themselves).

3.6 Provide Core Components of Runtime Scheduling Policy

With this developed, the key components of the runtime scheduling policy must next be put in place. The three main parts are as follows:

3.6.1 Heuristic Forward Scenario Generator

At any given time, the runtime scheduler will only have presented to it, by the various logical threads in the controlling executives, the very next deterministic engine request to be considered for execution. Happily, though the use of the transition matrices discussed above, coupled with the costs of engine execution available from the engine resource profiles, it becomes possible for the scheduler to derive a number of possible forward scenarios for evaluation.

However, even were it possible, we do not want to look ‘infinitely’ into the future, because this would cause a combinatorial explosion in the considered state space. Nor do we even want to look a uniform ‘fixed’ number of hops ahead, since some schedules may be more promising than others. The problem here is cognate to that faced by chess-playing software, which must consider the possible future consequences of various moves. Not all possible outcomes will be considered (even within the constraints of e.g. a 2 move ‘lookahead’), but rather a set of heuristics will be utilised to determine which scenarios should be expanded further. Our stochastic scheduling policy faces a cognate challenge.

Indeed, the heuristics that are used for scenario generation may themselves be subject to optimisation as part of the overall development of the stochastic simulation policy (since the purpose is to optimise performance of the final serialised schedule according to the analysis metric).

3.6.2 Develop Planning Metrics

With the scenario generation heuristics in place, the next required step is to provide a set of planning metrics. These are used to analyse the merits of each of the candidate scenarios produced by the generation heuristics, and ultimately to allow each to be represented by a single scalar ‘goodness’ value.

The overall domain for these planning metrics will probably span some or most of the following ‘objective’ measures, evaluated on a per-timeslice and per-timeslice-group basis:
Overall memory utilisation.
Overall timeslice utilisation.
Proximity to deadlines (where known).
Power utilisation.

A number of more heuristic metrics may also be employed. Referring back to our ‘chess software’ analogy, the objective metrics would be cognate to valuing outcome positions based on piece values, and the heuristics cognate to rules such as ‘bishops placed on open diagonals are worth more than ones that command fewer free squares’.

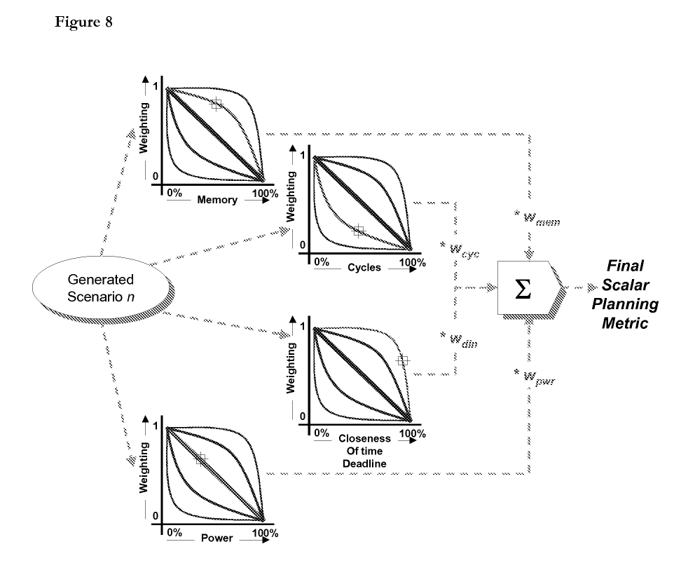

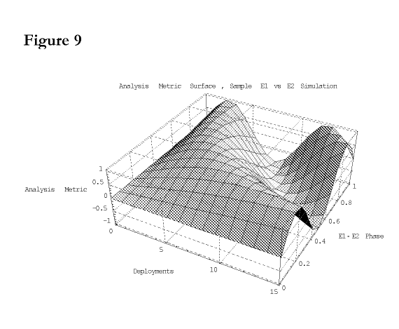

However, with all the metrics, the system designer is able to set the transfer function curvature—determining, in effect, whether the system responds early or late to resource shortages, and in addition, the system designer is able to determine the relative weights to assign to each of the planning metrics that together add to give the final single scalar value. The overall situation is shown in FIG. 8, showing how the system designer can set the initial response curve and overall weightings to derive a master scalar planning metric.

3.6.3 Provide a ‘Lazy’ Recalculation Dispatcher

Having generated the scalar planning metrics for each of the candidate scenarios at a given timestep, the scheduling policy must select the optimal candidate under that metric, and then commit a number of engine requests to the underlying RTOS for execution. Note that at this point there may be multiple underlying RTOS threads assigned and multiple ‘parallel’ RTOS tasks scheduled. The stochastic policy is required to set the overall RTOS priority for these submitted tasks.

Having submitted the schedule, the dispatcher component has completed its job and the overall scheduler policy will return to the quiescent state. To keep the overheads of calculation as low as possible, it is assumed that:
The scheduler policy will be implemented in such as a way as to maximise the amount of forward state maintained between analyses.
As each new engine call is presented for execution, the scheduler should consider whether this allows genuinely ‘new’ decisions to be taken. If it does not, then the dispatch should simply execute according to the previously computed priorities and logical→RTOS thread mappings. This will quite often be the case, where, for example, an engine within a plane has completed but there are still more engines to execute within that plane. However, in a number of circumstances there will be genuine need to recalculate (e.g., where a new message has been injected into a plane), and the scheduler policy must take appropriate action in such cases. The desired behaviour of the scheduler policy (with cashing and minimal recomputation) we refer to as a ‘lazy dispatch’ model.

3.7 Derive Actual Figure of Merit in ‘Beating’ Scenario

With the candidate stochastic scheduling policy in place, the next step is to run a set of traffic simulations against the (e.g.) E1 and E2 executives, and then to consider the final serialised schedules produced using an overall analysis metric. The serialised schedule represents a timeslice-by-timeslice record of which tasks were actually scheduled for processing. Note that it is assumed that E1 and E2 will be fed data from source drivers, which will simulate any appropriate relative frame time slippage and/or jitter over a large number of frames.

The analysis metric is the final arbiter of the ‘goodness’ of the scheduling fit, and should not be confused with the planning metrics, which are run-time heuristics applied with limited forward knowledge. The goal of the planning metrics is to optimise the overall analysis metric outcome for the concomitant schedule. Returning to our chess software analogy, the analysis metric would equate to the ratio of games won, drawn and lost; the planning metrics (such as ‘aim for positions that put your bishops on open diagonals, where possible’) to the heuristics that experience has shown tend to optimise the probability of achieving a win (or at least a draw). It is only with exhaustive lookahead that planning metrics and analysis metrics can be converged in form, so in general we aim only to converge them in effect.

The actual analysis metric used in practice will depend upon the system designer. One might simply regard any schedule that gives a fit as being good enough. A more sophisticated analysis, though, might use scripting to vary (e.g.) the number of channels and/or the bandwidth of the channels deployed, and then measure the schedule by the point at which the number of failed schedules (situations where denial of service occurs) exceeds a given maximum tolerance threshold. For example, we might stipulate that no more than 1 frame in 1000 of El, or 1 frame in 100 of E2, be dropped, and then (assuming for simplicity that E2 is a fixed bandwidth service) increase the data rate through the E1 modem until this threshold is exceeded. The last ‘successful’ bandwidth could then be regarded as the output of the analysis metric, and used to compare two candidate scheduling policies.

3.8 Detect and Correct any Resource Conflicts

Starvation occurs when the executive's requests for engine processing cannot be met within the necessary overall deadlines (which are usually set implicitly by frame arrival rates into the modem, if not explicitly by ‘worst time to reply’ constraints within the standard itself.

Note that where multiple standards exist, they will ‘beat’ against one another unless their timings are locked (which will be fairly rare). Furthermore, this ‘phase offset’ will not necessarily precess regularly, as independent stochastic effects in routing, engine execution or both may occur within any of the compound executives. The system designer will need to use the stimulus scripts to get a good coverage of this underlying potential phase space (which should be plotted as an analysis metric surface). Assuming that this space is continuous, then a ‘coarse grid’ analysis may be performed first, with a more ‘zoomed in’ approach being taken where starvation effects occur. There space in general will be multidimensional; for example, with a number of different considered deployments representing another potential axis of exploration, as shown in FIG. 8.

If, in this example, 0 were to represent the least acceptable overall analysis metric value, then we can see that for certain values of E1-E2 phase all deployments after number 4 have an unacceptable region of behaviour. The system designer would therefore wish to concentrate primarily on the acceptable deployments (for example, using more memory efficient engines, were that to be the bottleneck).

The CVM system designer tool will be used to explore the deployment state space. This process may itself be automated in a subsequent version of CVM.

When the simulation demonstrates an unacceptable level of an analysis metric being generated, the system designer has one of a four main possible avenues of attack open:
1. Modify the overall system behaviour, for example, by trying out a new equalisation technique. This will require dropping back to RadioLab, and so will rarely be the option of choice.
2. Loosen the constraint, and recompute the analysis metric. This will also rarely be a viable option.
3. Select a new deployment (in which, for example, more efficient engines may be utilised, possibly with the aid of some forward declaration).
4. Modify the planning metric transfer functions and weights to provide a better expected analysis metric outcome. This is the step considered next.

3.9 Optimise Planning Metric Weights

Once a relatively stable deployment has been attained, the designer can turn to the question of optimising the stochastic planning metrics. Both the transfer functions (curvature—do we ‘panic early’ or ‘panic late’ on a given resource) and the overall weights (used to combine together the various metric outputs into a single scalar) may be modified.

Again, we must remember that the overall purpose of our enquiry is to come up with a set of planning metrics that has the highest possible (and sufficiently high in an absolute sense) expected analysis metric outcome for its serialised schedules, without any ‘unacceptable’ cases as we range through the remaining free variables in the system (which, having fixed on a deployment in the previous step, will primarily refer to the relative phase of the multiple stacks as they ‘beat’ against one another). Going back to our chess program analogy, we are trying in this step to decide questions such as “what relative weight should we give to the ‘bishop on open diagonal’ rule (planning metric) if we want to optimise the system's probability of winning (analysis metric) against a player of a certain known skill, given 2 levels of lookahead?”

A number of different optimisation techniques may be used to climb the overall n-dimensional ‘hill’ (assuming that the results show it to be a continuous membrane!). Techniques such as simulated annealing and genetic algorithm selection are generally regarded as having good performance characteristics in this domain.

In all analyses of system performance, the resource requirements of the runtime scheduler itself must be taken into consideration, and that leads us to consideration of the final stage in the development of a stochastic policy.

3.10 Verify Performance Against Simple Scheduler

The analysis of the relatively complex runtime system must be considered against what would be achieved through the use of a more straightforward RTOS scheduler directly. The latter would not have the advantage of information about the resource requirements of engines prior to executing them, and nor would it have access to any ‘lookahead’ capability based upon the transition matrices; however, neither would it have the scenario generation and metric evaluation costs of the stochastic policy to contend with.

We have established in our discussion above the necessary tools to be able to answer the question of relative performance; we simply have to feed the same sample stimulus set into a model that uses the candidate predictive scheduling policy, and then repeat this test using a ‘direct mapped’ RTOS, perhaps with a policy such as first-come-first-served, or earliest-deadline-first. In this implementation, the CVM simply passes inbound engine requests directly to the scheduler (and would use a single thread priority as a first pass), rather than passing them through the stochastic machinery of scenario generation, planning metric analysis, and optimal scenario selection prior to any actual RTOS scheduling requests being issued.

In this analysis, we must be careful to analyse and factor in the overhead due to the scheduler itself. The use of run-to-completion semantics within multi-engine objects, taken together with the ‘lazy’ evaluation model discussed earlier, can help to lower this overhead significantly, by reducing the number of times that the expensive scenario generation is run.

In most cases, such an analysis will demonstrate significant benefit flowing from the use of the stochastic simulations, and this benefit will be quantified through the use of a common net-of-costs analysis metric.

Clearly, such a metric may also represent a very useful way for an organisation to express and prove the behaviour of its technology to customers, because it directly links to revenue: for example, if the analysis metric were to be ‘number of concurrent AMR voice channels sustained with <0.01 frame drop probability’, then we could (e.g.) state that our design obtained an analysis metric of 25 (channels), compared to (e.g.) a naive design capable of only 10 channels on the same hardware. This would provide a direct value statement for the CVM runtime—it is nominally worth 15 channels (at some $/channel) in our example.

With the predictive policy built, optimised and validated it can be shipped as part of a final system. It is not currently thought likely that any significant runtime ‘learning’ capability (e., in-situ updates to the transfer functions and weights of the planning metrics, or to the scenario generation logic) will take place in the initial release, but this may be appropriate for later versions of the CVM software.

4. Other Issues

Finally, there are a number of additional issues that are worth mentioning briefly.

4.1 Starvation Handling

Starvation occurs when necessary system processing does not occur in a timely fashion, because inappropriate resources were available to schedule it. For a number of cases, a ‘smarter’ scheduling policy can produce significantly better performance, but ultimately, as loadings increase, there comes a point where even the most sophisticated policies cannot cope, and at this point the system has to be able to fail some of the requests in a systematic manner. Such failure might actually be part of the envisioned and accepted behaviour of the system—a necessary cost of existing in a bursty environment. The important thing is that the scheduler takes action and degrades the system performance gracefully, rather than invoking a catastrophic failure.

Doing this requires that the scheduler be able to propagate error ‘exceptions’ back to the requesting plane, which can then invoke the necessary handlers, ideally integrated with the methods which handle normal channel defaults.

4.2 Scheduling Modes

It is likely that, under analysis, we will find that a system (such as a basestation) may profitably be configured in a number of different distinct ‘modes’. For example, dealing with 1) a large number of fairly similar voice subscribers, 2) with mixed traffic, and 3) with a relatively small number of quite high volume data subscribers, might represent three modes for a basestation; and a similar (traffic-graduated) analysis may be found accurate for handsets as well.

For this reason, we would like to be able to have executives communicate mode information to the underlying scheduler, which would keep ready a set of different transfer functions and weights to be swapped in for each specific mode.

4.3 Scheduling Hints

Similarly, we may want ‘intelligent’ executives to be able to pass scheduling ‘hints’, containing (for example) information about likely forthcoming engine requests, to enable more accurate decisions to be made by the CVM. In this sense, any data passed about proximity to deadlines from the executive to the scheduler constitutes a hint.

Appendix 1: CVM definitions

The following table lists and describes some of the terms commonly referred to in this Detailed Description section. The definitions cover the specific implementation described and hence should not be construed as limiting more expansive definitions given elsewhere in this specification.

| Term | Description |
|---|---|
| ASIC | Application-Specific Integrated Circuit. |
| | An integrated circuit designed to perform a particular |
| | function by defining the interconnection of a set of basic |
| | circuit building blocks, which are taken from a library |
| | provided by a circuit manufacturer. |
| Assembly | An assembly of devices, derived devices, other assemblies |
| | and buses, which defines their connectivity. |
| Baseband | A telecommunication system in which information is |
| | superimposed, where the frequency band is not shifted |
| | but remains at its original place in the electromagnetic |
| | spectrum. |
| Behavioural Simulator | A simulator that allows a developer to explore how a |
| | particular function may perform within a system but |
| | without actually generating the detailed design |
| | configuration (in the case of a DSP, its software) for the |
| | target device. A behavioural model ensures that inputs |
| | and outputs are accurate but the internal implementation |
| | is created in a different way to the hardware it is |
| | attempting to model. RadioScape's initial behavioural |
| | simulator is the RadioLab3G product that supports the |
| | W-CDMA FDD standard. |
| Bit True | Accurately reflecting the behaviour of a particular |
| | implementation. Every bit of data output is identical to |
| | that which would be generated by a hardware |
| | implementation of the function being modelled. |
| CSV | Comma Separated Values. |
| | Text based format for a data file with fields separated by |
| | commas. |
| CVM | Communication Virtual Machine ™. |
| | RadioScape's CVM methodology produces a Runtime |
| | Kernel that handles resource management, hardware |
| | abstraction and scheduling. The CVM Runtime Kernel is |
| | deployed through the use of RadioScape's CVM Toolset. |
| COM | Component Object Model. |
| | Microsoft's mechanism to allow one piece of software to |
| | call services supplied by another, regardless of their |
| | relative locations. Usually distributed as DLL files. |
| Conformance Test | A test to establish whether an implementation of an |
| | Engine matches the functionality of its Reference engine |
| | behavioural equivalent. |
| | This test is executed by the EDK as a plug-in to the |
| | semiconductor vendor supplied integrated development |
| | environment. Both the particular fixed-point polymorph |
| | of the behavioural model and the proposed |
| | implementation are simulated with the same stimulus |
| | vectors and the results compared. In some cases the |
| | comparison is a simple matching of numbers whereas in |
| | others it is necessary to evaluate whether the |
| | implementation equals or betters the performance of the |
| | behavioural equivalent. |
| CVMGen | A tool in the CVM family for generating stub code for |
| | engines. |
| Cycle Accurate Simulator | A simulator that is dedicated to accurately modelling the |
| | behaviour of a particular hardware implementation. The |
| | data output is accurately represented at each clock cycle |
| | and contains knowledge of the impact of cache memory, |
| | pipeline and look-ahead, etc. This type of simulation, by |
| | its very nature, takes requires considerable processing |
| | power to perform and so is only suitable for short |
| | simulation runs. |
| Data Type | The data type that can be used by a parameter. |
| Deployment | A Layer-1 system based on the CVM Runtime Kernel |
| | which can be developed using the CVM Toolset. |
| DLL | Dynamic Linked Library. |
| | A type of library that becomes linked to a program that |
| | uses it only temporarily when the program is loaded into |
| | memory or executed rather than being permanently built |
| | in at compilation time. |
| Dorsal Connection | Control Input connection on Planes or Modules |
| DSP | Digital Signal Processing. |
| | Computer manipulation of analogue signals that have |
| | been converted to digital form (sampled). Spectral |
| | analysis and other signal processing functions are |
| | performed by specially optimised Digital Signal |
| | Processors. Digital Signal Processors are super versions |
| | of RISC/maths co-processors in VLSI (Very Large Scale |
| | Integration) chip form, although they differ from maths |
| | co-processors in that they are independent of the host |
| | computer and can be built into a standalone unit. Like |
| | RISC, they depend on a small core of instructions that |
| | are optimised at the expense of a wider set. They are |
| | often capable of special addressing modes that are unique |
| | to a particular application. |
| Engine | A particular type of high resource function that has been |
| | Conformance tested and Performance profiled with |
| | EDK. |
| | Such a function usually consumes significant processor |
| | cycles and/or memory; common examples include a Fast |
| | Fourier Transform, Finite Input Response Filter and |
| | Complex Vector Multiply. Specifically an Engine is |
| | invoked in a standardised way and with a standardised |
| | approach to data marshalling. Access to RTOS functions |
| | is normalised through RadioScape's CVM Runtime |
| | Kernel. An Engine runs an Algorithm to implement a |
| | particular transform. An Engine is the lowest level of |
| | code class element within the RadioScape programming |
| | model for Layer-1. |
| Engine Co-Class | The Engine Co-Class is responsible for passing requests |
| | through to the underlying implementation, while also |
| | ensuring that, for example, all appropriate memory |
| | allocation invariants are met. It conforms to the Engine |
| | Type interface. |
| EDK | Engine Development Kit. |
| | RadioScape's tool for introducing new Engines to the |
| | RadioScape environment. Configured as a plug-in to the |
| | semiconductor vendor's code development tool. |
| | Certifies the Conformance to a polymorphic ‘gold’ |
| | standard behavioural model and Performance |
| | characteristics of an Engine. Following performance |
| | testing the characteristics may be substituted for low- |
| | level simulation within the Predictive Simulator. |
| Engine Interface | The Engine Interface describes the format of the calls |
| | that the engine must handle. |
| FFT | Fast Fourier Transform. |
| | An algorithm to convert a set of uniformly spaced points |
| | from the time domain to the frequency domain. |
| FIR | Finite Impulse Response. |
| | A type of digital signal filter, in which every sample of |
| | output is the weighted sum of past and current samples |
| | of input, using only a finite number of past samples. |
| Fixed Point | A number representation scheme in which a fixed |
| | number of bits are used to represent a numerical value. |
| | Calculations using this method are subject to inaccuracy |
| | due to the difference between approximate |
| | representations with a limited number of bits turning |
| | every number, including fractions, into integers. |
| | This mode is important on the RadioLab3G tool since it |
| | enables the behavioural models to more accurately |
| | represent the limitations of the physical implementation. |
| Flip Flop | A digital logic circuit that can be in one of two states, |
| | which its inputs cause it to switch between. |
| Forward Declared Engines | The process of providing the Performance Certificate for |
| | an engine, together with estimated values, in order to |
| | perform stochastic simulation before engine construction |
| | is complete. |
| | Once engine construction is complete, the forward |
| | declared Engine can be replaced by a Performance |
| | Certificate derived from a real engine implementation. |
| FPGA | Field-Programmable Gate Array. |
| | A gate array, where the logic network can be |
| | programmed into the device after its manufacture. It |
| | consists of an array of logic elements: either gates or |
| | lookup table RAMs (Random Access Memory), flip-flops |
| | and programmable interconnect wiring. |
| Framework | A framework is a CVM Layer-1 application specific |
| | development. It may consist of a set of planes, modules |
| | and/or engines. |
| Reference engine Blocks | Polymorphic Fixed Point Bit-true Behavioural |
| | descriptions of high resource functions. |
| | These are effectively the behavioural versions of Engines. |
| | These Blocks come with a set of test vectors for |
| | Performance Testing and Conformance testing. A block |
| | is considered the Reference engine as it is used as the |
| | definitive statement of functionality. |
| Hardware End-Points | A hardware Engine is a dedicated physical |
| | implementation designed to perform a specific high |
| | resource function. Engines can be implemented in either |
| | hardware or software. Such an Engine may handle either |
| | Streaming implementations where data is continually |
| | processed without intervention, or Block implementation |
| | where fixed amounts of data are processed in each |
| | activation. RadioScape describes the necessary interfaces |
| | to be created to treat the block as a ‘hardware endpoint’. |
| | Such an end point may be substituted at a design time |
| | with either hardware or software implementations of an |
| | Engine. |
| Hardware-in-the-loop | At any point in either Engine or System Development |
| | behavioural or cycle accurate simulation models may be |
| | replaced by physical implementations of Engines running |
| | on representative silicon. |
| HRF | High Resource Function. |
| | A function within a Layer-1 implementation that has |
| | been identified as consuming substantial systems |
| | resources, usually processor cycles, and/or memory. |
| | Common examples include a Fast Fourier Transform, |
| | Finite Input Response Filter and Complex Vector |
| | Multiply. These functions are not usually specific to the |
| | wireless standard being implemented. An HRF that has |
| | been conformance and performance tested within EDK |
| | is referred to as an Engine. |
| IDE | Integrated Development Environment. |
| | A system that supports the process of developing |
| | software. This may include a syntax-directed editor, |
| | graphical entry tools, and integrated support for |
| | compiling and running software and relating compilation |
| | errors back to the source. |
| Inflate | This engine method enables you to give an identifying |
| | name for an allocation of memory along with the size |
| | you want the memory block to be. CVM can then track |
| | this memory so that you don't have to worry about it. |
| Layer-1 | First layer of the OSI seven layer Model. |
| | Layer-1 is the physical layer relating to signalling and |
| | modulation schemes. Typically in modern wireless |
| | standards these are implemented in digital signal |
| | processor devices (DSPs) and so will have high software |
| | content. |
| MIPS | Million Instructions Per Second. |
| | The unit commonly used to give the rate at which a |
| | processor executes instructions. |
| Module | Modules are aggregation elements that can contain an |
| | arbitrary number (>=0) of (sub-) modules and engines. |
| | Modules contain code, which can invoke these contained |
| | components, but which itself does not consume |
| | significant system resources, and so may be written in |
| | platform-independent C++. Data processing within a |
| | module runs imperatively once started, and the CVM |
| | runtime guarantees that at most one thread will ever be |
| | active within a given plane instance at any time. Modules |
| | have access to a more sophisticated memory model than |
| | engines, and may also send and receive control messages. |
| Parameter | One of the items of data that passes into or out of an |
| | engine. |
| Performance Certificate | Digital certificate that references an associated CSV file |
| | that holds a set of resource usage characteristics under |
| | different conditions for particular physical |
| | implementations of a high resource function. |
| | This data is generated by the Performance Test. |
| Performance Test | The aim of the performance test is to create a |
| | Performance Certificate that can be used with the |
| | Performance Simulator. The test involves executing a set |
| | of stimulus vectors against an Engine under test and |
| | recording the results. The test vectors aim to build up a |
| | set of points on a multi-dimensional surface that can later |
| | be interpolated to make useful estimates of execution |
| | time and resource usage. A key parameter, say data |
| | length, will be varied and the number of cycles recorded |
| | at each point. Key variables may be expanded to provide |
| | data for other variables such as bus loading, or other |
| | shared resources so creating a multi-dimensional profile. |
| | During Simulation the best estimate for resource |
| | utilisation is found by looking up the appropriate closest |
| | matches within the performance certificate and |
| | interpolating the result. This process is performed within |
| | the EDK plug-in. |
| Plane | Planes are top-level synchronisation objects that contain |
| | a single module, and which communicate using |
| | asynchronous message passing. |
| Plug-in | A small program that adds extra function to some larger |
| | application. EDK operates as a plug-in to the vendor's |
| | development tool environment. |
| Policy | A policy is used by schedulers to schedule data |
| | processing. |
| Polymorphic | Functions that can be applied to many different data |
| | types. Used in this context to indicate the ability of |
| | behavioural blocks to operate at different bit widths |
| | internally and externally, and have different overflow |
| | behaviours. This is valuable in allowing behavioural |
| | models to more accurately represent the physical |
| | implementation. |
| PPO | Parameter Passing Option. |
| | These stipulate the seven main ‘modes’ in which a |
| | parameter may be passed into a method (namely: in, |
| | inout, out, incast/outcast, infree and inshared and |
| | outalloc). Core types T and arrays of core types can be |
| | passed as method arguments. |
| Python | A freeware interpreted Object Oriented Scripting |
| | Language used for creating test scripts of Performance |
| | and Conformance testing and the Stimulus for Predictive |
| | Simulation. See http://www.python.org |
| RadioLab3G | RadioScape's behavioural simulator supporting the |
| | W-CDMA FDD radio interface. The tool is based on |
| | Matlab/Simulink and uses the same ‘Gold’ standard |
| | blocks as the EDK conformance tool. |
| Rake | Digital section of a CDMA receiver which permits |
| | receiver to separate out the relevant signal from all the |
| | other signals. |
| RTOS | Real Time Operating System. |
| | A class of compact and efficient operating system for use |
| | in embedded systems. Relevant examples include DSP |
| | BIOS, OSE, Virtex and VDK. The CVM Runtime |
| | Kernel normalises the presented functions of common |
| | RTOS products so that Engines can operate in a number |
| | of environments. |
| Re-entrant | Code that has multiple simultaneous, interleaved, or |
| | nested invocations, which do not interfere with each |
| | other. |
| Resource | The quantity of a resource type a specific element has. |
| RISC | Reduced Instruction Set Computer. |
| | A processor where the design is based on the rapid |
| | execution of a sequence of simple instructions rather |
| | than a large variety of complex instructions. Features |
| | which are generally found in RISC designs are: uniform |
| | instruction encoding, which allows faster decoding; a |
| | homogenous register set, allowing any register to be used |
| | in any context and simplifying complier design; and |
| | simple addressing modes with more complex modes |
| | replaced by sequences of simple arithmetic instructions. |
| Runtime | CVM Runtime is made up of both standard CVM |
| | Runtime components and application-specific, |
| | components designed by you. The standard CVM |
| | Runtime components provide the core Runtime |
| | functionality, common to all CVM applications. |
| SDCL | System Development Class Library. |
| | Allows users to build modules and planes, and then |
| | combine these into a system framework. It also provides |
| | an RTOS abstraction layer. |
| Simulation Run | The results of simulating a particular deployment using |
| | the simulator. |
| Stateful | To avoid context switching, RadioScape's Engines are |
| | stateful. This means they preserve their state information |
| | from one invocation to the next. Accordingly, it is not |
| | necessary to reconfigure parameters or prime data when |
| | the function is called. |
| Predictive Scheduling | The use of statistical information harvested at design |
| | time during a Training Run that enables runtime- |
| | scheduling decisions to be made more efficiently at |
| | runtime. |
| Stochastic Simulation | A type of simulation where certain functions rather than |
| | being modelled at a low granularity are replaced by |
| | statistically based estimates of time and resource usage. |
| | The resulting output while not data accurate is useful in |
| | understanding complex system performance in a short |
| | elapsed time simulation run. The Stochastic Simulator is |
| | part of the CVM System Development Kit. |
| UE | User Equipment. |
| | 3G terminology that emphasises that future user devices |
| | may not be simple voice handsets but may take different |
| | forms; wrist phone, car navigation device, camera, PDA, |
| | etc. |
| Ventral Connection | Control output connection on Planes and Modules |
| Viterbi | An algorithm to compute the optimal (most likely) state |
| | sequence in a hidden Markov model, given a sequence of |
| | observed outputs. |
| XML | eXtensible Markup Language. |
| | A simple SGML dialect. The goal of XML is to enable |
| | generic SGML to be served, received, and processed on |
| | the Web in the way that is now possible with HTML. |
| | While simpler than SGML, XML has a more flexible tag |
| | definition system than the format based tags used in |
| | HTML. This allows a far wider range of information to |
| | be stored and exchanged than is possible with HTML. |
| | Many CVM definitions are stored in XML file format. |
| | Refer to http://www.w3.org/XML/ |

1. A device comprising a communications stack split into:
(i) engines designed to perform real time DSP or communications high resource functions;
(ii) executives designed to perform low resource functions, including issuing requests for engine execution tasks; and
(iii) a scheduler that receives the requests and schedules execution of those tasks by an underlying RTOS, the scheduler using its knowledge of the likelihood of engine request state transitions, obtained during simulation, to make, at runtime, scheduling decisions based on evaluating several possible future scenarios.

2. The device of claim 1 in which the scheduler is a service of a virtual machine layer separating the engines from the executives.

3. The device of claim 1 in which the scheduler uses engine resource utilisation profiles.

4. The device of claim 3 in which the engine resource utilisation profiles cover both cycles and memory.

5. The device of claim 1 comprising multiple communications stacks operating concurrently and the scheduler is able to dynamically balance the requirements of the stacks.

6. The device of claim 1 in which executives cannot invoke engines directly but only through the scheduler.

7. The device of claim 1 in which the likelihood of engine request state transitions describes the likely sequence of engines which the executives will impose and is represented as a table or matrix for each of several different executives.

8. The device of claim 1 in which the scheduler decides which engine execution tasks are to be submitted to the underlying RTOS for execution, how many RTOS threads to use, at what priority and at each logical timestep.

9. The device of claim 8 in which the likelihood of engine request state transitions is a relative-frequency-based probability estimate of the likelihood of a given engine being called, given that a known prior engine was called.

10. The device of claim 8 in which the scheduler operates a runtime scheduling policy comprising a heuristic forward scenario generator that takes a set of submitted immediate engine requests and generates an incomplete set of possible future scenarios, based upon the state transition information.

11. The device of claim 10 in which the scheduler operates a runtime scheduling policy comprising a set of planning metrics that can be used to evaluate each of the possible future scenarios, weighing up the relative importance of one or more of the following factors: (a) memory utilisation, (b) timeslice utilisation, (c) proximity to deadline, (d) power utilisation, and generating a single scalar score.

12. The device of claim 11 in which the planning metrics reflect choices made at design time to weight the factors differently.

13. The device of claim 11 in which the planning metrics reflect choices made at design time to determine whether the device responds early or late to resource shortages.

14. The device of claim 11 in which the scheduler operates a dispatcher that takes the highest scoring such scenario and schedules all forward non-contingent threads onto the underlying RTOS.

15. The device of claim 11 in which the scheduler is able to degrade system performance gracefully, rather than invoking a catastrophic failure, by failing some requests in a systematic manner.
